(19) United States
(12) Patent Application Publication
(10) Pub. No.: US 2005/0134568 A1
(43) Pub. Date: Jun. 23, 2005

(54) Method and system for providing a rotated keyboard and angled display in a hand-held computing device

(75) Inventors: David W. Hill, Cary, NC (US); Hisashi Shima, Yamato-shi (JP); Kazuhiko Yamazaki, Hiratsuka-city (JP)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/738,181

(22) Filed: Dec. 17, 2003

(51) Int. Cl. G09G 5/00

(52) U.S. Cl. 345/169

(57) ABSTRACT

A method and system for providing hand-held computing device is disclosed. The hand-held computing device includes a display and a keyboard that is coupled with the display. The keyboard is rotatable through at least ninety degrees to be oriented in a portrait mode or a landscape mode.

### FIELD OF THE INVENTION

The present invention relates to computer systems, and more particularly to a method and system for providing a hand-held computing device.

### BACKGROUND OF THE INVENTION

Hand-held computing devices such as personal digital assistants (PDAs), certain cellular telephones, and blackberry devices, are of increasing interest to both manufacturers and consumers. Currently, most conventional hand-held computing devices have a conventional human interface that includes a conventional keyboard or keypad and a conventional display screen encapsulated in a case. When closed, the case protects the conventional keyboard, conventional display, and internal circuitry. Typically, the conventional case slides open, revealing the conventional keyboard and conventional display, which are fixed in place. Some conventional hand-held computing devices open by rotating the conventional display rotates with respect to the conventional keyboard. Once open, the conventional keyboard and conventional display can be used to enter and view data.

Although conventional hand-held computing devices function, one of ordinary skill in the art will readily recognize that the conventional human interface may be difficult to use. In particular, the configuration and size of the conventional keyboard and display may make is relatively difficult for a user to enter information. Furthermore, the orientation of the conventional display may make it difficult to view the desired information.

Accordingly, what is needed is a system and method for providing an improved human interface for a hand-held computing device. The present invention addresses such a need.

### SUMMARY OF THE INVENTION

The present invention provides a method and system for providing a hand-held computing device. The hand-held computing device includes a display and a keyboard that is coupled with the display. The keyboard is rotatable through at least ninety degrees to be oriented in a portrait mode or a landscape mode.

According to the system and method disclosed herein, the present invention provides a hand-held computing device having a human interface that is more flexible and simpler to use.

### BRIEF DESCRIPTION OF THE DRAWINGS

FIG. 1A is a diagram of one embodiment of a hand-held computing device in accordance with the present invention when open and the keyboard is in a landscape orientation.

FIG. 1B is a diagram of one embodiment of a hand-held computing device in accordance with the present invention when open and the keyboard is rotated to be in a first portrait orientation.

FIG. 1C is a diagram of one embodiment of a hand-held computing device in accordance with the present invention when open and the keyboard is rotated to be in a second portrait orientation.

FIG. 1D is a diagram of one embodiment of a hand-held computing device in accordance with the present invention when closed.

FIG. 2A is a diagram of one embodiment of a hand-held computing device in accordance with the present invention when open and the keyboard is used in a portrait orientation.

FIG. 2B is a diagram of one embodiment of a hand-held computing device in accordance with the present invention when open and the keyboard is used in a portrait orientation and the display is angled in a first desktop orientation.

FIG. 2C is a diagram of one embodiment of a hand-held computing device in accordance with the present invention when open and the keyboard is used in a portrait orientation and the display is angled in a second desktop orientation.

FIG. 2D is a diagram of one embodiment of a hand-held computing device in accordance with the present invention when used in a landscape orientation.

### DETAILED DESCRIPTION OF THE INVENTION

The present invention relates to an improvement in hand-held computing devices. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention provides a method and system for providing a hand-held computing device. The hand-held computing device includes a display and a keyboard that is coupled with the display. The keyboard is rotatable through at least ninety degrees to be oriented in a portrait mode or a landscape mode.

The present invention will be described in terms of a particular hand-held computing device having a keyboard and display. However, one of ordinary skill in the art will readily recognize that this method and system will operate effectively for other hand-held computing devices having other and/or additional components including other keyboards and/or displays.

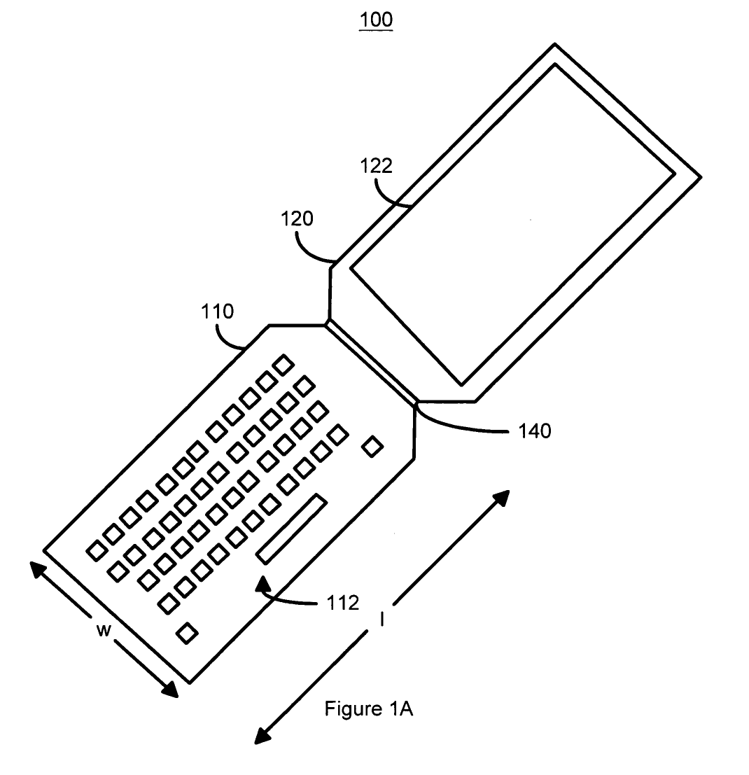

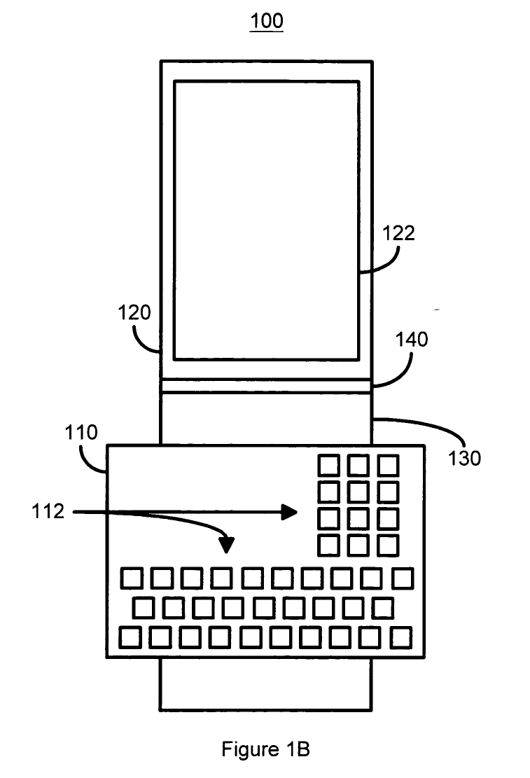

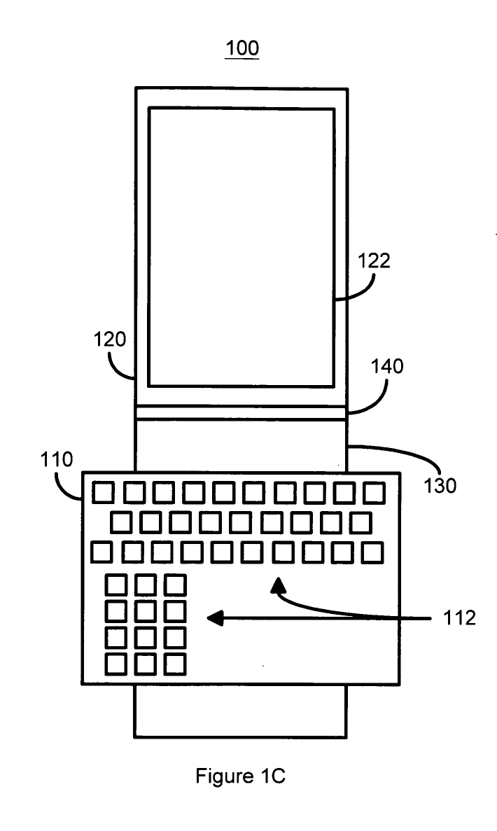

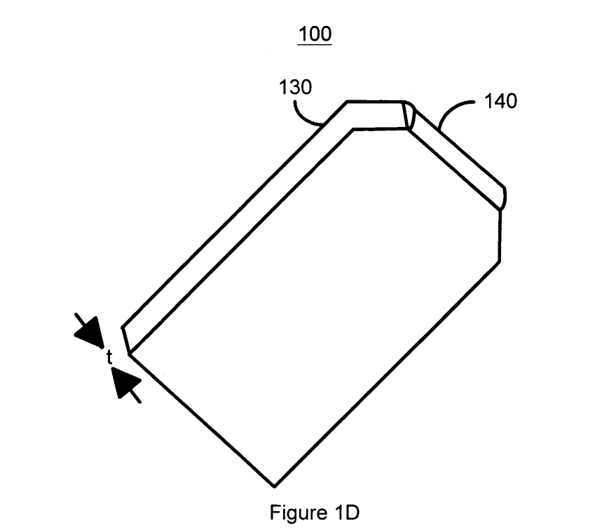

To more particularly illustrate the method and system in accordance with the present invention, refer now to FIG. 1A, depicting a diagram of one embodiment of a hand-held computing device 100 in accordance with the present invention when open and the keyboard is in a landscape orientation. The hand-held computing device 100 includes a keyboard 110 and a display 120. The display 120 includes a display screen 122 that is preferably an LCD display. However, in an alternate embodiment, the display screen 122 could be another type of screen. The keyboard 1 10 includes keys 112. In the embodiment shown, the keyboard 110 is a QWERTY keyboard. However, in another embodiment, another type of keyboard 110 could be used. For example, the keys 112 could be arranged in a different layout or could simply be numeric keys for a keypad. In a preferred embodiment, the dimensions of the hand-held computing device 100 are such that the width, w, is approximately two and three-quarters inches and the length, l, is approximately four and one-half inches. However, in an alternate embodiment, the hand-held computing device 100 could have other dimensions.

FIGS. 1B and 1C are a diagram of the embodiment of a hand-held computing device 100 in accordance with the present invention when open and the keyboard 110 is rotated to be in a first portrait orientation and a second portrait orientation, respectively. Referring to FIGS. 1A, 1B, and 1C, the keyboard 110 can thus preferably be in a landscape orientation, as shown in FIG. 1A, or one of two portrait orientations shown in FIGS. 1B and 1C. In an alternate embodiment, the keyboard 110 can take on only one of the two portrait orientations. In yet another alternate embodiment, the keyboard 110 could take on either of two landscape orientations (shown in FIG. 1A or another that is not shown wherein the keyboard is one hundred and eighty degrees with respect to the orientation shown in FIG. 1A) and at least one of the two portrait orientations (shown in FIGS. 1B and 1C). In the first portrait orientation shown in FIG. 1B, the keyboard 110 is oriented such that the letter keys are at the bottom of the keyboard 110, distant from the display 120. In the second portrait orientation shown in FIG. 1C, the keyboard 110 is oriented such that the letter keys are at the top of the keyboard 110, in proximity to the display 120.

In operation in the portrait mode shown in FIG. 1B or 1C, the information is depicted on the display screen 122 preferably appears right-side up to a user viewing the keyboard 110 right-side up. Stated differently, the information displayed on the display screen 122 is preferably provided in a portrait orientation while the keyboard 110 is in the portrait orientations depicted in FIGS. 1B and 1C. In a preferred embodiment, the hand-held computing device 100 is also usable in a landscape mode, when the keyboard 110 is in the landscape orientation shown in FIG. 1A. In such a mode, the information depicted on the display screen 122 is preferably in a landscape orientation when the keyboard 110 is in the landscape orientation. Thus, regardless of the orientation of the keyboard 110, the information provided on the display screen 112 is easily understandable by a user.

FIG. 1D is a diagram of one embodiment of the hand-held computing device 100 in accordance with the present invention when closed. In a preferred embodiment, the thickness, t, of the hand-held computing device 100 is approximately ¾ inch when the hand-held computing device 100 is closed. Thus, the hand-held computing device is enclosed in a protective cover 130 when closed. In a preferred embodiment, the display 120 and keyboard 110 are integrated into the protective cover 130.

In a preferred embodiment, the display 120 is rotatable. Thus, to open the hand-held computing device 100, moving from the orientation shown in FIG. 1D to that shown in FIG. 1A, the display is rotated from closed to the desired orientation. To rotate the display 120, a hinge 140 is thus also preferably provided. However, nothing prevents the use of another mechanism for opening the hand-held computing device 100 and/or for rotating the display 120.

Thus, the hand-held computing device 100 can easily be used in multiple orientations, depending upon the preference of the user. Because the keyboard 110 can be rotated to be in the portrait orientation of FIG. 1B and/or 1C, the keyboard can be made larger while allowing the display screen 122 to provide information to the user in the desired orientation. The human interface provided by the display 120 and keyboard 110 thus make it easier for a user to enter data into and read data from the hand-held computing device 100.

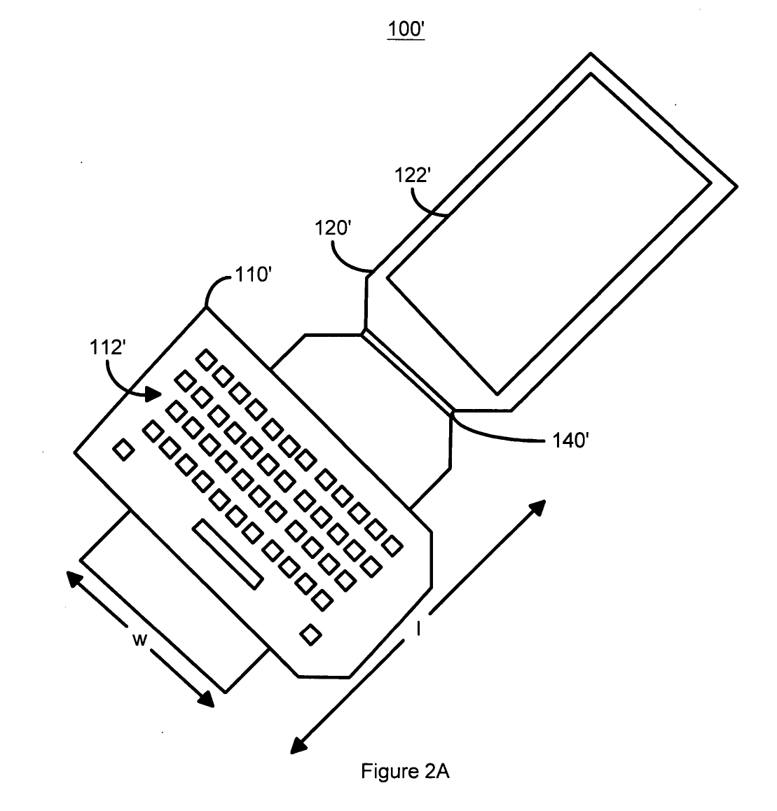

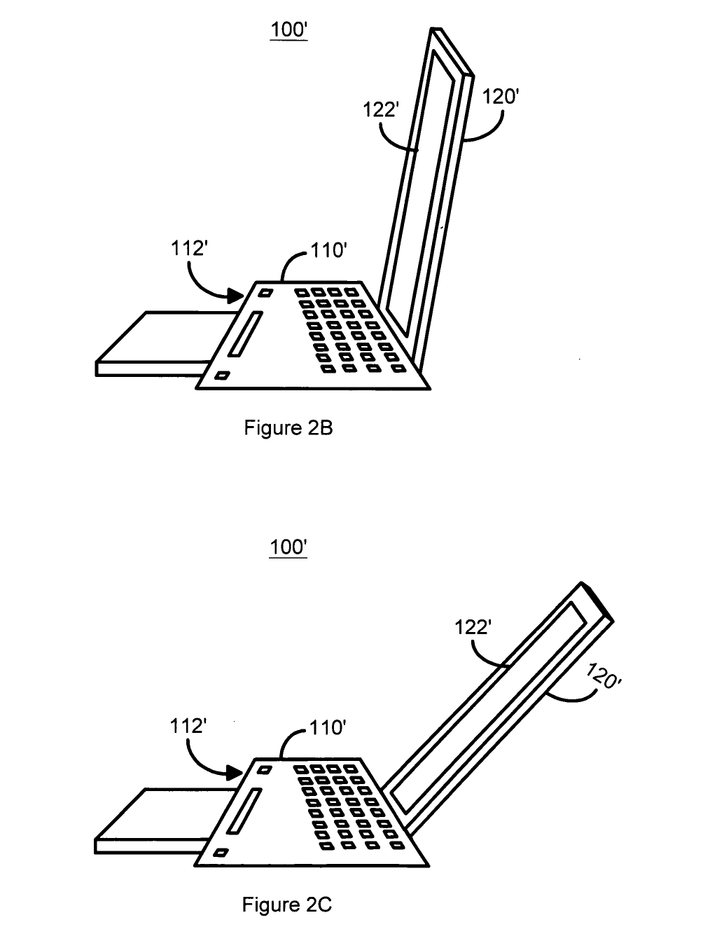

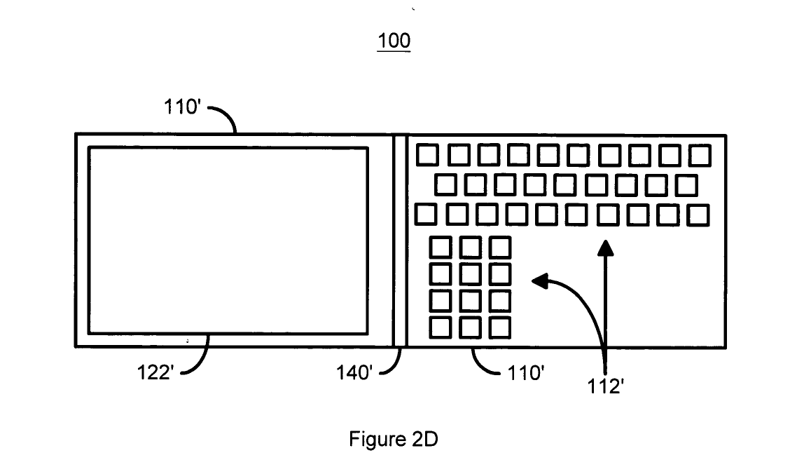

FIG. 2A is a diagram of one embodiment of a hand-held computing device in accordance 100′ with the present invention when open and the keyboard is used in a portrait orientation. The hand-held computing device 100′ is preferably analogous to the hand-held computing device 100. Thus, like components are labeled similarly. Consequently, keyboard 110′ and the display 120′ correspond to the keyboard 110 and the display 120 depicted in FIGS. 1A-1D. In addition, the hand-held computing device 100′ is opened by rotating the display 120′ with respect to the keyboard 110. In the orientation shown in FIG. 2A, the display 120′ has been rotated through approximately one hundred and eighty degrees. Thus, the keyboard 110′ and the display 120′ are substantially flat. In addition, the keyboard 110′ is in a portrait orientation. Thus, information is preferably provided on the display screen 122′ in a portrait orientation. In a preferred embodiment, when the display 120′ is rotated to a desired position, the display 120′ remains in that position until subject to an outside force, preferably from a user moving the display 120′ to a new position. FIGS. 2B-2C depict other positions for the display 120′ and the keyboard 110′.

FIG. 2B is a diagram of one embodiment of the hand-held computing device 100′ in accordance with the present invention when open and the keyboard 110′ is used in a portrait orientation and the display 120′ is angled in a first desktop orientation. In the orientation depicted in FIG. 2B, the display 120′ has been angled to be approximately ninety degrees from the keyboard 110′ while the keyboard 110′ is in a portrait orientation. Thus, the configuration of the human interface provided by the combination of the keyboard 110′ and the display 120′ is substantially that of a desktop computer. Thus, information is preferably depicted on the display screen 122′ in a portrait orientation. Because the display 120′ stays in substantially the orientation set by the user, data can be easily viewed by the user on the display screen.

FIG. 2C is a diagram of one embodiment of the hand-held computing device 100′ in accordance with the present invention when open and the keyboard 110′ is used in a portrait orientation and the display 120′ is angled in a second desktop orientation. The display 120′ is angled between approximately ninety degrees and one hundred and eighty degrees from the keyboard 110′. Thus, information is preferably depicted on the display screen 122′ in a portrait orientation. Because the display 120′ stays in substantially the orientation set by the user, data can be easily viewed by the user on the display screen. A user might select this orientation when viewing the hand-held computing device 100′ from a higher up (a smaller angle with respect to vertical).

FIG. 2D is a diagram of one embodiment of a hand-held computing device 100′ in accordance with the present invention when used in a landscape orientation. Thus, the keyboard 110′ and the display 120′ are oriented at an angle of approximately one hundred and eighty degrees. In this respect, the hand-held computing device 100′ is in an orientation similar to that depicted in FIG. 2A. However, the keyboard 110′ is in a landscape orientation. Consequently, when used in this landscape mode, information is preferably depicted on the display screen 122′ in a landscape orientation.

Thus, the hand-held computing device 100′ can be used in portrait mode (FIGS. 2A-2C) and landscape mode (FIG. 2D). In addition, the display screen 122′ can be viewed from a variety of angles-from substantially flat (FIGS. 2A and 2D), to other desired orientations that may be similar to what would be selected for a desktop (FIGS. 2B and 2C). Consequently, in addition to the advantages described above with respect to the hand-held computing device 100, the hand-held computing device 100′ provides greater flexibility of use. In particular, the user can more easily see the data depicted on the display screen 122′ from a number of different positions. Thus, the human interface formed using the display 120′ and the keyboard 110′ is further improved.

A method and system has been disclosed for providing a hand-held computing device having an improved human interface. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A hand-held computing device comprising:
a display; and
a keyboard coupled with the display, the keyboard being rotatable through at least ninety degrees to be oriented in a portrait mode or a landscape mode.

2. The hand-held computing device of claim 1 wherein the display is rotatable with respect to the keyboard.

3. The hand-held computing device of claim 2 further comprising:
a hinge for coupling the keyboard to the display, the hinge for allowing the display to rotate with respect to the keyboard.

4. The hand-held computing device of claim 3 wherein the display is rotatable to have an orientation of at least ninety degrees with respect to the keyboard and wherein the display remains in the orientation until moved by an external force.

5. The hand-held computing device of claim 3 further comprising:
a protective cover integrated into the keyboard and the display such that when the display is rotated to be in contact with the keyboard, the hand-held computing device is substantially encased in the protective cover.

6. The hand-held computing device of claim 1 wherein the keyboard is usable in the portrait mode or the landscape mode.

7. The hand-held computing device of claim 1 wherein the hand-held computing device is a personal digital assistant.

8. The hand-held computing device of claim 1 wherein the hand-held computing device is a cell phone.

9. The hand-held computing device of claim 1 wherein the keyboard is a QWERTY keyboard.

10. A method for providing hand-held computing device comprising:
providing a display; and
providing a keyboard coupled with the display, the keyboard being rotatable through at least ninety degrees to be oriented in a portrait mode or a landscape mode.

11. The method of claim 10 further comprising the step of:
coupling the display to the keyboard such that the display is rotatable with respect to the keyboard.

12. The method of claim 11 wherein the coupling step further includes the step of:
coupling the display to the keyboard using a hinge, the hinge for allowing the display to rotate with respect to the keyboard.

13. The method of claim 12 wherein the display is rotatable to have an orientation of at least ninety degrees with respect to the keyboard and wherein the display remains in the orientation until moved by an external force.

14. The method of claim 12 further comprising the step of:
integrating a protective cover into the keyboard and the display such that when the display is rotated to be in contact with the keyboard, the hand-held computing device is substantially encased in the protective cover.

15. The method of claim 10 wherein the keyboard is usable in the portrait mode or the landscape mode.

16. The method of claim 10 wherein the hand-held computing device is a personal digital assistant.

17. The method of claim 10 wherein the hand-held computing device is a cell phone.

18. The method of claim 10 wherein the keyboard is a QWERTY keyboard.
